(19) United States
(12) Patent Application Publication
(10) Pub. No.: US 2024/0341520 A1
(43) Pub. Date: Oct. 17, 2024

(54) Vacuum Assisted Coffee Grinder

(71) Applicant: Saint Anthony Industries, Ltd, Salt Lake City, UT (US)

(72) Inventor: Khristian Bombeck, Salt Lake City, UT (US)

(21) Appl. No.: 18/633,600

(22) Filed: Apr. 12, 2024

Related U.S. Application Data
(60) Provisional application No. 63/464,698, filed on May 8, 2023.
(60) Provisional application No. 63/459,612, filed on Apr. 15, 2023.

(51) Int. Cl. A47J 31/42

(52) U.S. Cl. CPC A47J 31/42

(57) ABSTRACT

A vacuum assisted coffee grinder assembly includes a coffee grinder having a grinder discharge and a vacuum chamber in fluid communication with the grinder discharge. The vacuum chamber has a chamber outlet. The vacuum chamber removes chaff and other unwanted particulate from ground coffee beans. Optionally, a vibrating screen can also be provided to prevent larger particulates from being discharged from the assembly.

### BACKGROUND OF THE INVENTION

### Field of the Invention

The invention relates to a coffee grinder with a vacuum draw away unwanted chaff and other unwanted parts of a coffee bean.

### Description of the Related Art

An unavoidable residue from grinding coffee is the resulting chaff, which is a natural byproduct. While the chaff is not harmful to ingest, it adds nothing to the flavor of the coffee and actually dilutes the coffee flavor.

One step after grinding the coffee is to vacuum away the chaff with a hand-held vacuum or to blow on the chaff, dispersing the chaff, which floats away from the ground beans. This vacuuming or blowing requires an additional step in the grinding process.

It would be beneficial to provide a device to automatically remove the chaff and other waste particulates during the grinding process.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention is a vacuum assisted coffee grinder assembly that includes a coffee grinder having a grinder discharge and a vacuum chamber in fluid communication with the grinder discharge. The vacuum chamber has a chamber outlet. The vacuum chamber removes chaff and other unwanted particulate from ground coffee beans.

In another embodiment, the present invention provides a vacuum assisted coffee grinder assembly comprising a coffee grinder having a grinder discharge and a vacuum chamber in fluid communication with the grinder discharge. The vacuum chamber has a chamber outlet and an adjustable volume. An outlet tube has a first end in fluid communication with the grinder discharge and a second end located proximate to the chamber outlet.

In still another embodiment, the present invention provides a vacuum assisted coffee grinder assembly comprising a coffee grinder having a grinder discharge and a vacuum chamber in fluid communication with the grinder discharge. The vacuum chamber has a chamber outlet. An outlet tube has a first end in fluid communication with the grinder discharge and a second end located proximate to the chamber outlet. A vibrating screen is located at the chamber outlet

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a perspective view of a vacuum assisted coffee grinder according to an exemplary embodiment of the present invention;

FIG. 2 is a perspective view of a vacuum portion of the assembly of FIG. 1;

FIG. 3 is a perspective view of a discharge of a vacuum chamber used in the assembly of FIG. 1;

FIG. 4 is a perspective view of a controller used to control the vacuum in the assembly of FIG. 1;

FIG. 5 is a perspective view of an alternative embodiment of a vacuum assisted coffee grinder according to the present invention;

FIG. 6 is a perspective view of a screen at the discharge end of the grinder of FIG. 5; and

FIG. 7 is a perspective view showing coffee grounds discharged from the grinder of FIG. 5.

### DETAILED DESCRIPTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The word “about” is used herein to include a value of +/−10 percent of the numerical value modified by the word “about” and the word “generally” is used herein to mean “without regard to particulars or exceptions.”

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The present invention provides a coffee grinder with an attached vacuum system that allows ground coffee seed material to drop out but removes lighter chaff and other unwanted parts (waste product) of the coffee bean. The vacuum system is used to suck air at a discharge of the coffee grinder to clean and scrub the coffee. The present invention provides the ability to clean and optimize a coffee grind so the coffee exits the grinder and hits the cleaning mechanism, which acts like an air scrubber. The air scrubber sucks out the lightweight, undesirable particles, separating those particles from the desired coffee grinds. The inventor believes that about 15% of the original coffee is removed using the inventive device, and that the removed particles tend to contribute to a bitter taste in the coffee, so the removal of these particles results in an enhanced flavor of the coffee.

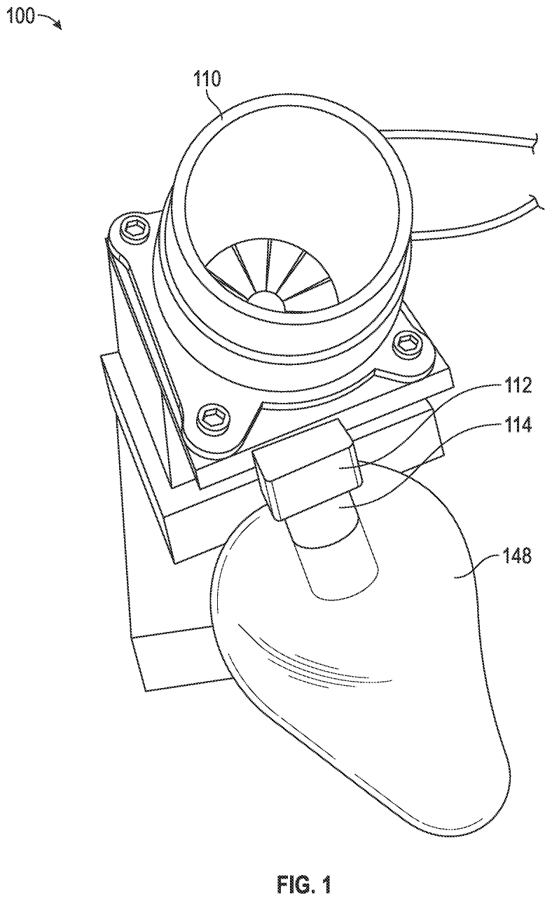

Referring to FIG. 1, a coffee grinder assembly 100 (“assembly 100”) according to an exemplary embodiment of the present invention is shown.

Assembly 100 includes a known coffee grinder 110 with a grinder discharge 112. Grinder discharge 112 includes an outlet tube 114 through which all ground particles of a coffee bean are discharged after grinding.

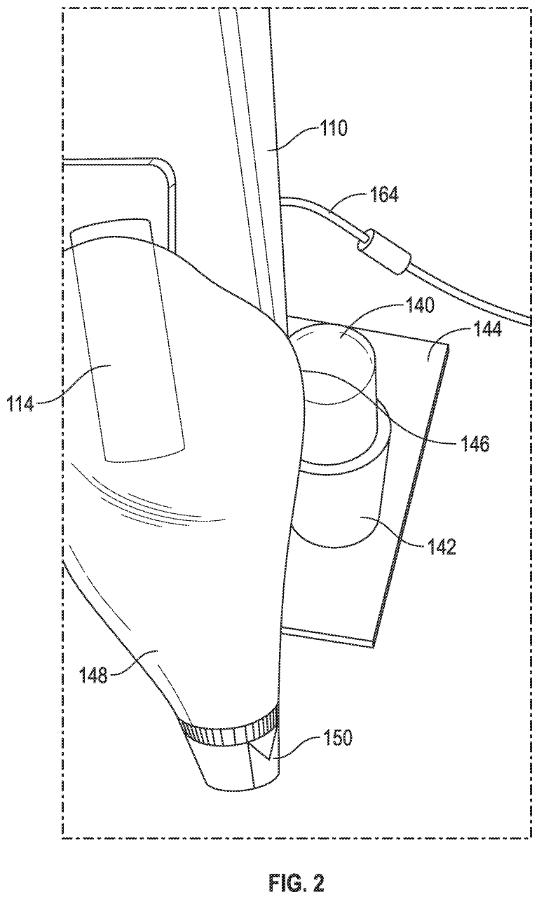

FIG. 2 shows a vacuum line 140 having a proximal end 142 attached to a vacuum device 144 and a distal end 146 attached to a vacuum chamber 148. Vacuum chamber 148 extends around and contains outlet tube 114 such that ground coffee material exits outlet tube 114 and enters vacuum chamber 148 proximate to an outlet 150 of vacuum chamber 148.

Optionally, outlet 150 of vacuum chamber 148 can have an adjustable size, which affects the strength of the vacuum inside vacuum chamber 148. Vacuum chamber 148 can include a first end portion 152 and a second end portion 154 that are not connected to each other, but can slide along each other to adjust the volume of vacuum chamber 148. A clamp 156, similar to a pipe clamp, can be attached to outlet 150 of vacuum chamber 148 and adjusted to correspondingly adjust the area of outlet 150. The adjustment of outlet 150 can affect the strength of the vacuum inside vacuum chamber 148 and, consequently, the size and amount of material sucked into vacuum line 140 and not discharged outside of outlet 150.

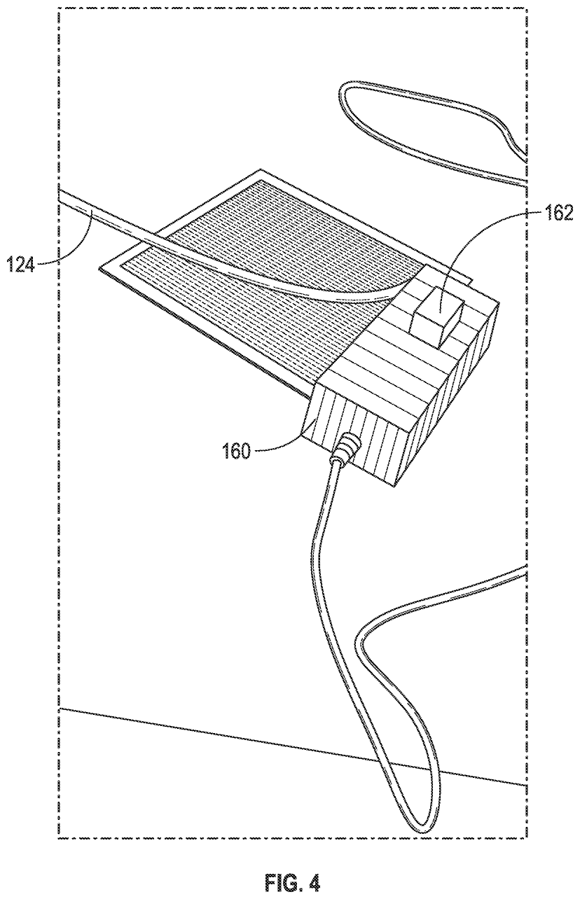

The strength of the vacuum and, consequently, the size of the waste product to be sucked in by vacuum line 140 can also be adjusted via a variable speed controller 160. As shown in FIG. 4, controller 160 is electrically connected to vacuum device 144 via a cable 164 and includes a potentiometer dial 162 that can be rotated to adjust the strength of the vacuum generated by vacuum device 142, depending on the particle size desired. Dial 162 can be turned down to get more coffee particles to come out of assembly 100.

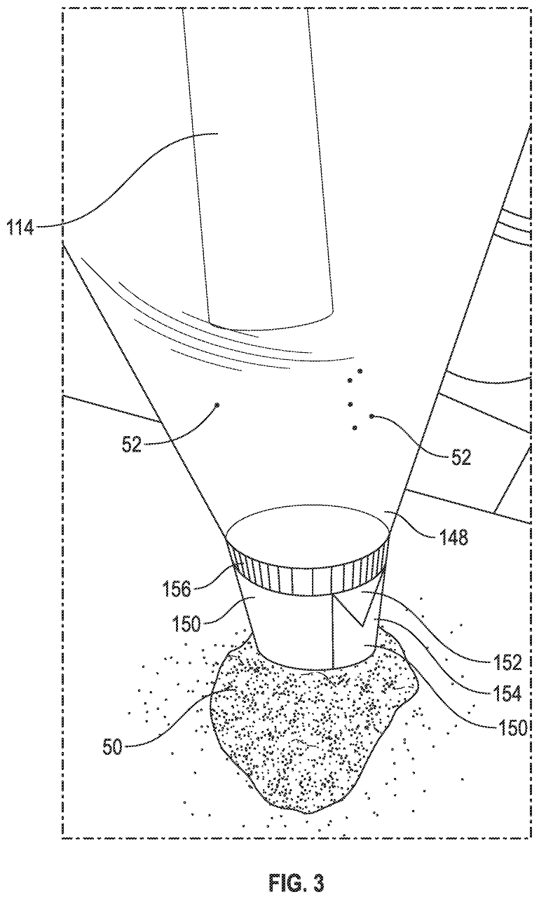

As shown in FIG. 3, desired coffee grounds 50 drop out of vacuum chamber 148, while chaff 52 remains in vacuum chamber 148 and is sucked into vacuum line 140 for discharge away from coffee grounds 50.

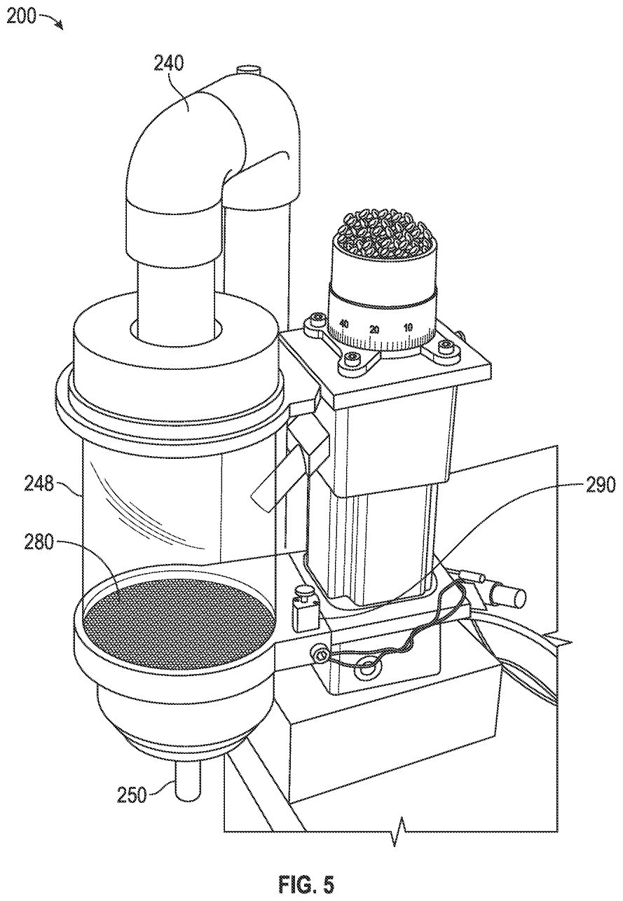

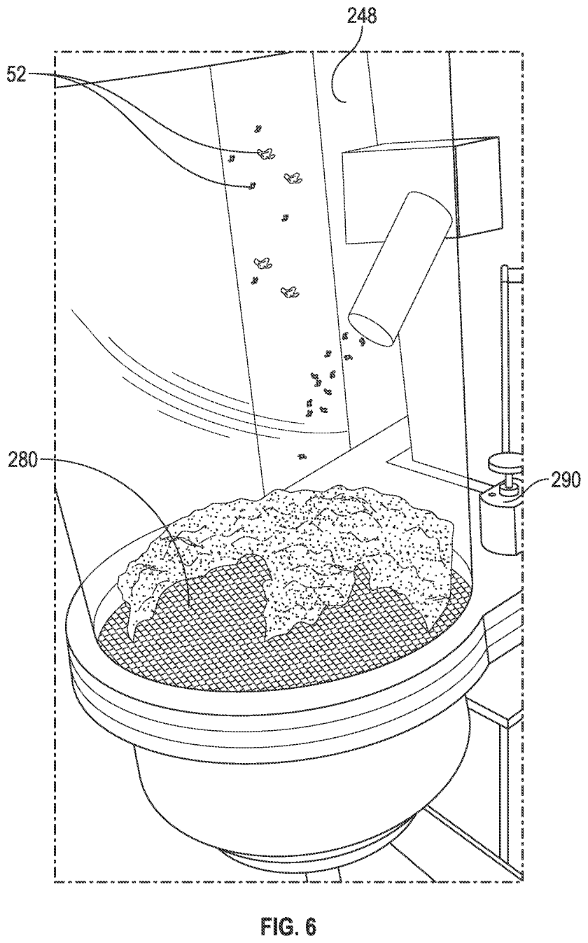

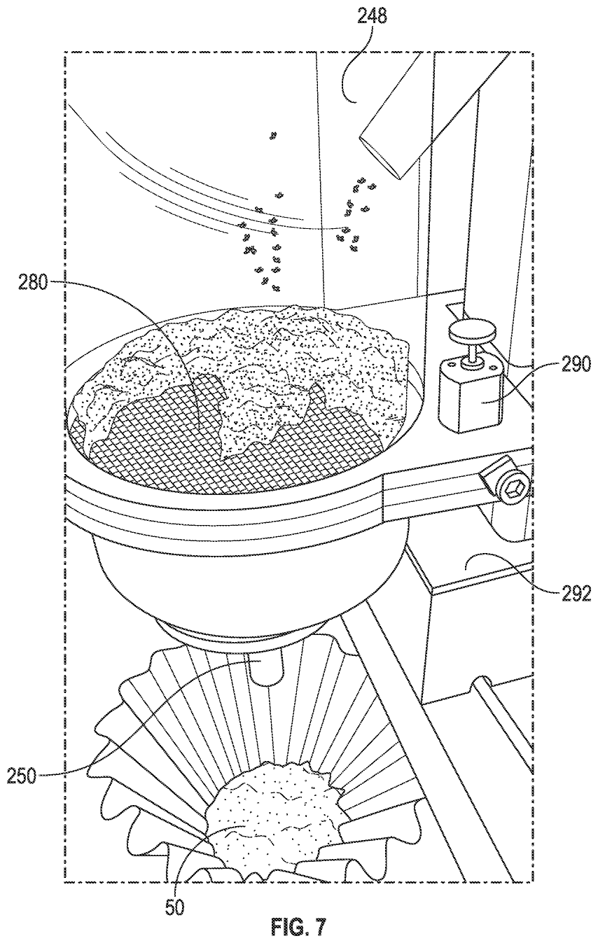

In an alternative embodiment of a grinder assembly 200 (“assembly 200”) according to the present invention and shown in FIGS. 5-7, assembly 200 further includes a vibratory screen 280 at an outlet 250 of vacuum chamber 248. Assembly 200 can be identical to assembly 100, with the addition of screen 280 at outlet 250.

A vibratory motor 290 is mounted on a base 292 and vibrates a lower end of vacuum chamber 248, along with screen 280. The vibrations help to separate the unwanted lightweight particles from the desired grounds so that the suction from vacuum line 240 can more easily suck the unwanted particles 52 upward and out of vacuum chamber 248, while the heavier grounds 50 fall through screen 280 and out the outlet 250.

The addition of vibratory motor 290 to assembly 200 helps to sort the ground coffee material by mass rather than by size. While the lighter unwanted particles 52 may be small enough to fit through the mesh of screen 280, the suction from vacuum line 240 suspends the unwanted particles 52 and draws them upward, away from screen 280 to be sucked into vacuum line 240 and away from the grounds 50.

It will be further understood that various changes in the details, materials, and arrangements of the parts which have been described and illustrated in order to explain the nature of this invention may be made by those skilled in the art without departing from the scope of the invention as expressed in the following claims.

I claim:

1. A vacuum assisted coffee grinder assembly comprising:
a coffee grinder having a grinder discharge; and
a vacuum chamber in fluid communication with the grinder discharge,
the vacuum chamber having a chamber outlet.

2. The vacuum assisted coffee grinder assembly according to claim 1, further comprising a vacuum device in fluid communication with the vacuum chamber.

3. The vacuum assisted coffee grinder according to claim 2, further comprising a variable speed controller electrically connected to the vacuum device.

4. The vacuum assisted coffee grinder according to claim 3, wherein adjustment of the variable speed controller adjusts a strength of the vacuum generated by vacuum device.

5. The vacuum assisted coffee grinder according to claim 1, further comprising an outlet tube having a first end in fluid communication with the grinder discharge and a second end located proximate to the chamber outlet.

6. The vacuum assisted coffee grinder according to claim 1, wherein the vacuum chamber has an adjustable volume.

7. The vacuum assisted coffee grinder according to claim 6, wherein the vacuum chamber comprises a first end portion and a second end portion, wherein the first end portion and the second end portion are slidable relative to each other to adjust the volume of vacuum chamber.

8. The vacuum assisted coffee grinder according to claim 1, further comprising a clamp attached to the chamber outlet.

9. The vacuum assisted coffee grinder according to claim 1, wherein the clamp is adjustable to adjust an area of the chamber outlet.

10. The vacuum assisted coffee grinder according to claim 1, further comprising a vibratory screen at the chamber outlet.

11. The vacuum assisted coffee grinder according to claim 10, further comprising a vibratory motor configured to vibrate a lower end of the vacuum chamber and the vibratory screen.

12. The vacuum assisted coffee grinder according to claim 11, wherein the vibratory motor is configured to sort ground coffee material by mass.

13. The vacuum assisted coffee grinder assembly according to claim 1, further comprising a vacuum line in fluid communication with the vacuum chamber.

14. The vacuum assisted coffee grinder assembly according to claim 13, wherein the vacuum line is located distally from the chamber outlet.

15. A vacuum assisted coffee grinder assembly comprising:
a coffee grinder having a grinder discharge;
a vacuum chamber in fluid communication with the grinder discharge, the vacuum chamber having a chamber outlet and an adjustable volume; and
an outlet tube having a first end in fluid communication with the grinder discharge and a second end located proximate to the chamber outlet.

16. The vacuum assisted coffee grinder assembly according to claim 15, further comprising a vibratory screen at the chamber outlet.

17. The vacuum assisted coffee chamber according to claim 15, wherein the chamber outlet has an adjustable size.

18. The vacuum assisted coffee grinder assembly according to claim 15, further comprising a vacuum device in fluid communication with the vacuum chamber.

19. The vacuum assisted coffee grinder assembly according to claim 15, wherein a strength of a vacuum generated by the vacuum device is adjustable.

20. A vacuum assisted coffee grinder assembly comprising:
a coffee grinder having a grinder discharge;
a vacuum chamber in fluid communication with the grinder discharge, the vacuum chamber having a chamber outlet;
an outlet tube having a first end in fluid communication with the grinder discharge and a second end located proximate to the chamber outlet; and
a vibrating screen at the chamber outlet.
